(19) United States
(12) Patent Application Publication
(10) Pub. No.: US 2022/0406277 A1
(43) Pub. Date: Dec. 22, 2022

(54) STORAGE ASSEMBLY FOR A MUSICAL DRUM SET

(71) Applicant: Jeremy Galloway, Waxahachie, TX (US)

(72) Inventor: Jeremy Galloway, Waxahachie, TX (US)

(21) Appl. No.: 17/833,096

(22) Filed: Jun. 6, 2022

Related U.S. Application Data
(60) Provisional application No. 63/212,821, filed on Jun. 21, 2021.

(51) Int. Cl. G10D 13/10

(52) U.S. Cl. CPC G10D 13/10

(57) ABSTRACT

A storage assembly for safely storing and transporting a musical drum set. The storage assembly includes a dolly and multiple cases for multiple drums of the musical drum set. The dolly includes a rigid round base, and a base skirt extends from a periphery of the rigid round base. One or more wheels and one or more telescoping arms coupled to a bottom of the rigid round base. First drum of the musical drum set can be encased in the dolly and rest of the drums can be encases within the cases. The drums packed in the cases are stacked one over another on the first drum.

### CROSS-REFERENCE TO RELATED APPLICATIONS

This application claims priority from a U.S. Provisional Patent Appl. No. 63/212,821 filed on Jun. 21, 2021, which is incorporated herein by reference in its entirety.

### FIELD OF INVENTION

The present invention relates to a storage assembly for a musical drum set, and more particularly, the present invention relates to multiple cases and a dolly for distinct size drums and accessories of a musical drum set.

### BACKGROUND

The musicians generally travel a lot to perform at different places and are therefore quite mobile in their careers. The musicians also have to carry a range of musical instruments for the performance. Most of the musical instruments are generally bulky and heavy to carry and typically require good care while transporting. Storage boxes and suitable packaging typically safeguard the musical instruments from damage during transit. Drummers also have to transport bulky and multiple types of equipment. However, there is a lack of suitable packaging options for the multiple drums. Transferring a drum set can be tedious and tiring for percussionists as each drum set can include multiple drums and other equipment which must be handled with care.

A need is therefore appreciated for a storage assembly for a drum set that can keep the drums safe in transit.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a storage assembly for a drum set that can safeguard the drum set from damage while transporting the drum set.

It is another object of the present invention that the multiple drums of the drum set can be stored and handled easily.

It is still another object of the present invention that the storage assembly is adaptable and adjustable.

It is yet another object of the present invention that the storage assembly allows the drums to be stacked.

It is an additional object of the present invention that the storage assembly can provide cushioning against bumps and shocks.

It is still an additional object of the present invention that the storage assembly itself is compact and easy to use.

In one aspect, disclosed is a storage assembly for a musical drum set, the storage assembly comprises a dolly configured to encase a first drum of the musical drum set. The dolly comprises a rigid round base, a diameter of the rigid round base is proportional to an outer diameter of the first drum; a base skirt extends from a periphery of the rigid round base, wherein a width of the base skirt is proportional to a height of the first drum; a plurality of base drawstrings extends from a periphery of the base skirt; one or more wheels coupled to a bottom of the rigid round base; one or more telescoping arms coupled to the rigid round base; and a handle coupled to the one or more telescoping arms.

In one implementation, the storage assembly further comprises a first case configured to encase a second drum of the musical drum set, the first case comprises: a first round flexible base; a first skirt that extends from a periphery of the first round flexible base, a diameter of the first round flexible base is proportional to an outer diameter of the second drum, a width of the first skirt is proportional to a height of the second drum, and a plurality of first drawstrings extends from a periphery of the first skirt.

In one implementation, the storage assembly further comprises a second case configured to encase a third drum of the musical drum set, the second case comprises: a second round flexible base; a second skirt that extends from a periphery of the second round flexible base, a diameter of the second round flexible base is proportional to an outer diameter of the third drum, a width of the second skirt is proportional to a height of the third drum, and a plurality of second drawstrings extends from a periphery of the second skirt.

In one implementation, the second drum is smaller in size than the first drum.

In one implementation, the second drum is smaller in size than the first drum, and the third drum is smaller in size than the second drum.

In one implementation, the one or more telescoping arms are coupled to the rigid round base through a hinge joint such that the one or more telescoping arms are capable of pivoting vertically relative to the horizontally placed rigid round base between a horizontal position and a vertical position.

In one implementation, the first case further comprises a first grab handle, the first grab handle comprises a grip configured to be grasped in a hand; and a fastening mechanism for releasably fastening the plurality of first drawstrings together.

In one implementation, the storage assembly further comprises a belt configured to secure the second drum, encased in the first case and placed over the first drum, to the one or more telescoping arms.

In one implementation, the storage assembly further comprises: a plurality of cases configured to encase a plurality of drums of the musical drum set, wherein each case of the plurality of cases comprises: a flexible round base; a skirt that extends from a periphery of the flexible round base; and a plurality of drawstrings that extends from a periphery of the skirt.

In one implementation, the storage assembly further comprises one or more sleeves, each sleeve of the one or more sleeves is configured to receive one or more drumsticks of the musical drum set, each sleeve has a fastener coupled to a top portion of the sleeve and the fastener is configured to secure the sleeve to a drawstring of the plurality of drawstrings.

In one implementation, the one or more telescoping arms are configured to extend between a minimum length and a maximum length, wherein the minimum length corresponds to the height of the first drum, wherein the maximum length corresponds to a combined height of drums of the musical drum set.

In one implementation, the storage assembly further comprises a plurality of reinforcing hollow tubes bonded to an outer surface of the base skirt, the plurality of reinforcing hollow tubes extends radially and along the width of the base skirt, each reinforcing hollow tube of the plurality of reinforcing hollow tubes comprises a rigid metal bar or a plastic bar running throughout a length of the reinforcing hollow tube.

In one aspect disclosed is a method for storing a musical drum set, the method comprising the steps of: providing a storage assembly comprising: a dolly configured to encase a first drum of the musical drum set, the dolly comprises: a rigid round base, a diameter of the rigid round base is proportional to an outer diameter of the first drum, a base skirt extends from a periphery of the rigid round base, wherein a width of the base skirt is proportional to a height of the first drum, a plurality of base drawstrings extends from a periphery of the base skirt, one or more wheels coupled to a bottom of the rigid round base, one or more telescoping arms coupled to the rigid round base, and a handle coupled to the one or more telescoping arms; placing the first drum over the base skirt; lifting the handle and the base skirt such that the base skirt is around the first drum; and fastening the plurality of base drawstrings together to secure the first drum.

In one implementation, the storage assembly further comprises a first case configured to encase a second drum of the musical drum set, the first case comprises a first round flexible base; a first skirt that extends from a periphery of the first round flexible base, a diameter of the first round flexible base is proportional to an outer diameter of the second drum, a width of the first skirt is proportional to a height of the second drum, and a plurality of first drawstrings extends from a periphery of the first skirt, wherein the method further comprises the steps of: placing the second drum over the first round flexible base; lifting the first skirt, such that the first skirt is around the second drum; fastening the plurality of first drawstrings together to secure the first case around the second drum; and upon fastening the plurality of first drawstrings, placing the second drum over the first drum encased in the dolly.

In one implementation, the second drum is smaller in size than the first drum.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a schematic view showing a case of a storage assembly in an unfolded state and the placement of a drum on the case, according to an exemplary embodiment of the present invention.

FIG. 2 is a schematic view showing the folding of the case and the drums of different sizes packed in the respective cases, according to an exemplary embodiment of the present invention.

FIG. 3 shows an enlarged view of a hollow tube of the case, according to an exemplary embodiment of the present invention.

FIG. 4 shows a sleeve of the storage assembly and securing of the sleeve to a drawstring of a case, according to an exemplary embodiment of the present invention.

FIG. 5 shows a dolly of the storage assembly, according to an exemplary embodiment of the present invention.

FIG. 6 illustrates a first drum secured to the dolly and the placement of other drums over the first drum, according to an exemplary embodiment of the present invention.

FIG. 7 shows each drum of the set of drums encased and the encased drums stacked, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be outlined to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is a storage assembly designed for percussionists to store and transport the drum sets easily, quickly, and safely. The disclosed storage assembly can protect the drums from shocks and bumps during handling and transportation. The storage assembly can have cases made from a durable material that prevents any scratches and damage to the drums from sharp objects and corners.

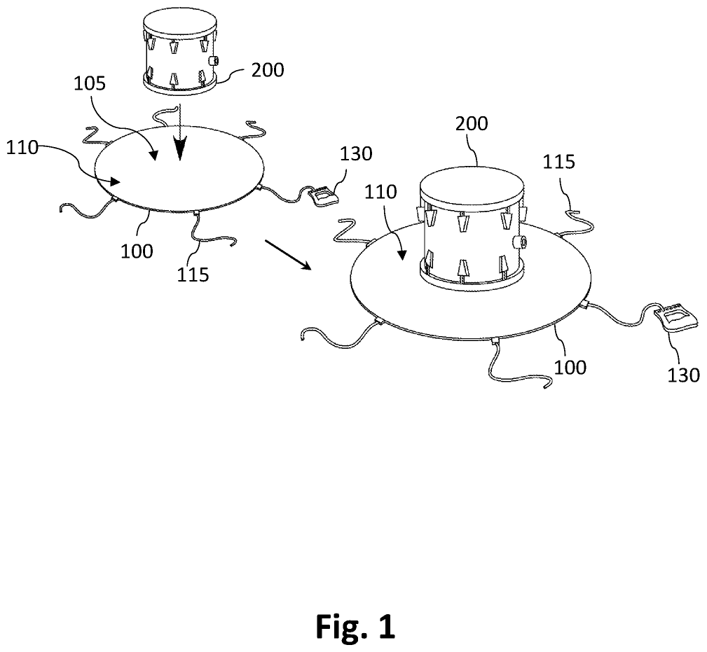

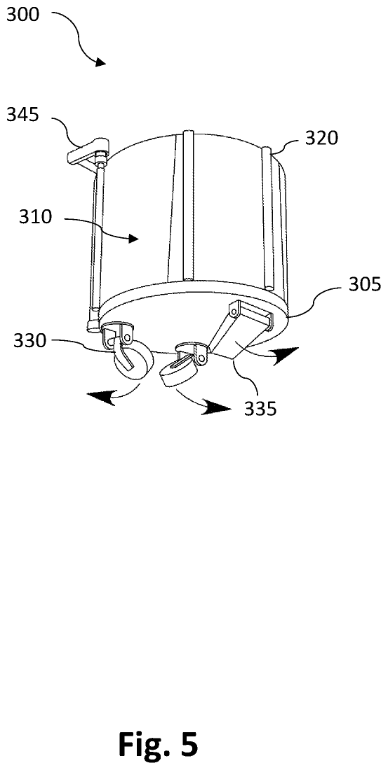

Referring to FIGS. 1-7 which show an exemplary embodiment of the storage assembly that includes multiple cases and a dolly. FIG. 1 is a schematic diagram showing a case 100 of the storage assembly and a drum 200 being encased in case 100. The case can encase a drum and can be secured using the drawstrings of the case. The case can include a round base 105, also referred to herein as a round flexible base, that can be of a diameter proportional to an outer diameter of the drum 200 which is packed in case 100. A skirt 110 extends from a periphery of the round base wherein the skirt can be continuous along the periphery of the round base. The width of the skirt can be proportional to the height of the drum. At least the skirt can be made from a flexible material so that when the drum is placed over the round base, the skirt can wrap around the walls of the drum. Preferably, the skirt and the base can be made from a thick fabric that can be flexible and compact, moreover, the thick fabric can prevent scratches and damage to the drum. The fabric can be provided with a layer of cushioning material, such as foam to safeguard the drum against bumps and shocks. The choice of material for the round base and the skirt can vary, and any such material is within the scope of the present invention. Preferably, the material can be flexible and durable and can include cushioning. In one implementation, the round base and the skirt can integrally form a single unit. Alternatively, the skirt and the round base can be separated and bonded at the edges using a suitable fastening mechanism, such as sewing.

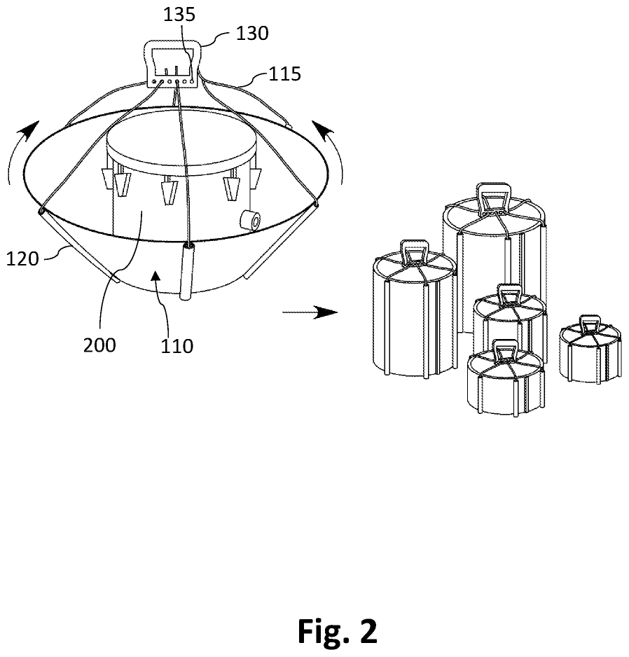

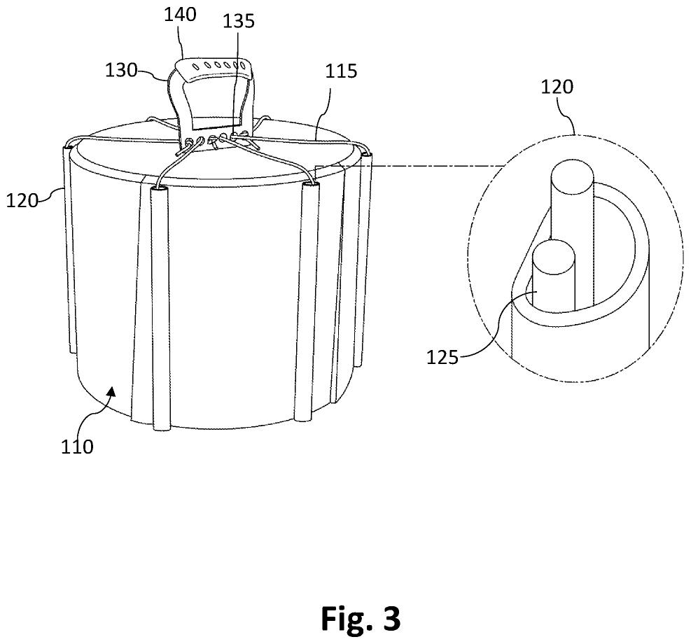

To secure the skirt around the drum, the case can further include drawstrings 115 that extend outwards from a periphery of the skirt. The drawstrings can be tightened around the drum and fastened together to secure the case around the drum. FIG. 1 shows six such drawstrings that extend from the periphery of the skirt and the six drawstrings are equally spaced from each other. FIG. 2 illustrates the fastening of the drawstrings to secure the drum 200. Referring to FIGS. 2 and 3, along the width of the skirt can also be provided hollow tubes 120 that radially extend from the periphery of the round base to the periphery of the skirt. The hollow tubes can be bonded to the outer surface of the skirt such that when the case is secured to a drum, the hollow tubes extend vertically along with the height of the drum. Within the hollow tubes can be provided reinforcing rods 125, such as metal rods that can help maintain the shape of the skirt and allow the skirt to be easily lifted and wrapped around the drum. The drawstrings can also be coupled to the hollow tubes because of the additional strength of the hollow tubes.

The case can further include a grab handle 130 coupled to at least one drawstring. The rest of the drawstrings can be fastened to the grab handle for securing the case to the drum. The grab handle can be provided with a suitable fastening mechanism to fasten the free ends of the drawstrings. FIG. 3 shows the grab handle having six holes 135 for the six drawstrings, such that a knot can be fixed to the holes. The grab handle can also include a grip 140.

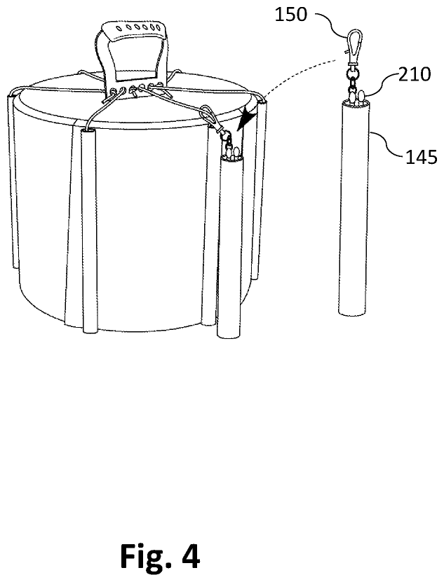

Referring to FIG. 4, the storage assembly can further include a sleeve 145 for holding the two drumsticks 210 of the drum 200. The sleeve can have a fastener 150, such as a carabiner that can be used to secure the sleeve to the grab handle or one of the drawstrings. FIG. 4 shows a carabiner secured to one of the drawstrings and the sleeve suspended along a wall of the drum.

As shown in FIG. 2, cases of different sizes can be provided for drums of different sizes. FIG. 2 shows five drums of different sizes encased in the disclosed cases of the storage assembly. Referring to FIGS. 4-7, one case, which is preferably the case for the biggest drum can be implemented as a dolly 300 of the storage assembly. The dolly 300 can have a round rigid base 305 that is durable and made from a sturdy material, and the skirt 310 extends from a periphery of the rigid round base 305. The dolly can have the skirt, drawstrings 315, hollow reinforcing tubes 320, and the fastener 325 for fastening the drawstrings as described above and hence not repeated here.

The dolly 300 can have one or more wheels 330, such as caster wheels at the bottom of the rigid round base 305. In one implementation, two wheels can be provided at the bottom of the rigid base, however, two or more wheels are within the scope of the present invention. In place of two wheels, one broad wheel can also be provided. Each of the wheels or one of the available wheels on the dolly can also be provided with brakes to keep the dolly stationary as and when required. A stopper 335 can also be provided at the bottom of the rigid base 305 wherein the stopper can be flipped down to engage the stopper and flipped up to disengage the stopper. The stopper can help to keep the dolly stable and stationary, such as during transit or storage.

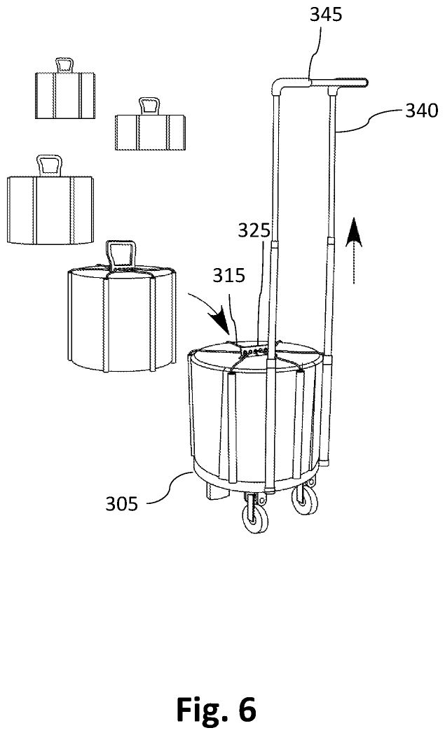

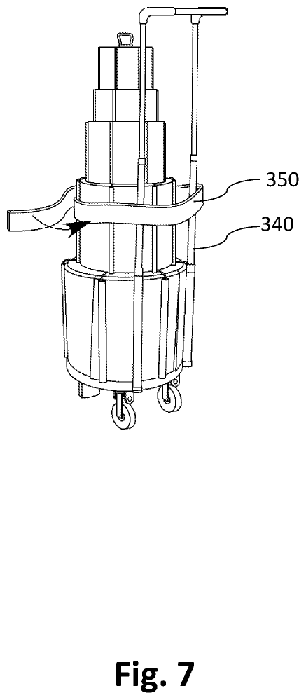

Two telescopic arms 340 can be provided coupled to the round rigid base 305 and the skirt 310 of the dolly 300, the two telescopic arms can pivot at the joint with the rigid base. A handle 345 can be coupled at the free end of the two arms, wherein the handle and the arms can pivot from a horizontal position to a vertical position, and from the vertical position to the horizontal position. While the casing of the dolly lies flat and the arms in the horizontal position, a drum can be placed on the rigid base, and thereafter, the skirt can be lifted to wrap around the drum. Thereafter, the drawstrings can be fastened to secure the case on the drum. The handle is also lifted with the skirt, and the handle can be pulled telescopically to increase the length of the arms. Thereafter, more packed drums can be placed one over another, as shown in FIGS. 6 and 7. The drums can be placed in increasing order of size with the biggest drum at the bottom and the smallest drum at the top. A belt 350 can be used to secure the packed drums to the two arms of the dolly as shown in FIG. 7. Also, the belt can be fixedly coupled to the skirt, and the belt can be wrapped around the two arms and fastened using suitable fasteners, such as a hook and loop fastener. It is to be noted that the dolly has been described as a rigid round base and a skirt that extends from a periphery of the rigid round base, however, in an alternate embodiment, a case as described in FIGS. 1 and 2 i.e., having a round flexible base can be placed on the round rigid base of the dolly.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A storage assembly for a musical drum set, the storage assembly comprises:
a dolly configured to encase a first drum of the musical drum set, the dolly comprises:
a rigid round base, a diameter of the rigid round base is proportional to an outer diameter of the first drum;
a base skirt extends from a periphery of the rigid round base, wherein a width of the base skirt is proportional to a height of the first drum;
a plurality of base drawstrings extends from a periphery of the base skirt;
one or more wheels coupled to a bottom of the rigid round base;
one or more telescoping arms coupled to the rigid round base; and
a handle coupled to the one or more telescoping arms.

2. The storage assembly according to claim 1, wherein the storage assembly further comprises
a first case configured to encase a second drum of the musical drum set, the first case comprises:
a first round flexible base;
a first skirt that extends from a periphery of the first round flexible base, a diameter of the first round flexible base is proportional to an outer diameter of the second drum, a width of the first skirt is proportional to a height of the second drum, and
a plurality of first drawstrings extends from a periphery of the first skirt.

3. The storage assembly according to claim 2, wherein the storage assembly further comprises
a second case configured to encase a third drum of the musical drum set, the second case comprises:
a second round flexible base;
a second skirt that extends from a periphery of the second round flexible base, a diameter of the second round flexible base is proportional to an outer diameter of the third drum, a width of the second skirt is proportional to a height of the third drum, and
a plurality of second drawstrings extends from a periphery of the second skirt.

4. The storage assembly according to claim 2, wherein the second drum is smaller in size than the first drum.

5. The storage assembly according to claim 3, wherein the second drum is smaller in size than the first drum, and the third drum is smaller in size than the second drum.

6. The storage assembly according to claim 1, wherein the one or more telescoping arms are coupled to the rigid round base through a hinge joint such that the one or more telescoping arms are capable of pivoting vertically relative to horizontally placed rigid round base between a horizontal position and a vertical position.

7. The storage assembly accordingly to claim 2, wherein the first case further comprises a first grab handle, the first grab handle comprises:
a grip configured to be grasped in a hand; and
a fastening mechanism for releasably fastening the plurality of first drawstrings together.

8. The storage assembly accordingly to claim 2, wherein the storage assembly further comprises a belt configured to secure the second drum, encased in the first case and placed over the first drum, to the one or more telescoping arms.

9. The storage assembly accordingly to claim 1, wherein the storage assembly further comprises:
a plurality of cases configured to encase a plurality of drums of the musical drum set, wherein each case of the plurality of cases comprises:
a flexible round base;
a skirt that extends from a periphery of the flexible round base; and
a plurality of drawstrings that extends from a periphery of the skirt.

10. The storage assembly according to claim 9, wherein the storage assembly further comprises:
one or more sleeves, each sleeve of the one or more sleeves is configured to receive one or more drumsticks of the musical drum set, each sleeve has a fastener coupled to a top portion of the sleeve and the fastener is configured to secure the sleeve to a drawstring of the plurality of drawstrings.

11. The storage assembly according to claim 1, wherein the one or more telescoping arms are configured to extend between a minimum length and a maximum length, wherein the minimum length corresponds to the height of the first drum, wherein the maximum length corresponds to a combined height of drums of the musical drum set.

12. The storage assembly according to claim 1, wherein the storage assembly further comprises:
a plurality of reinforcing hollow tubes bonded to an outer surface of the base skirt, the plurality of reinforcing hollow tubes extends radially and along the width of the base skirt, each reinforcing hollow tube of the plurality of reinforcing hollow tubes comprises a rigid metal bar or a plastic bar running throughout a length of the reinforcing hollow tube.

13. A method for storing a musical drum set, the method comprising the steps of:
providing a storage assembly comprising:
a dolly configured to encase a first drum of the musical drum set, the dolly comprises:
a rigid round base, a diameter of the rigid round base is proportional to an outer diameter of the first drum,
a base skirt extends from a periphery of the rigid round base, wherein a width of the base skirt is proportional to a height of the first drum,
a plurality of base drawstrings extends from a periphery of the base skirt,
one or more wheels coupled to a bottom of the rigid round base,
one or more telescoping arms coupled to the rigid round base, and
a handle coupled to the one or more telescoping arms;
placing the first drum over the base skirt;
lifting the handle and the base skirt such that the base skirt is around the first drum; and
fastening the plurality of base drawstrings together to secure the first drum.

14. The method according to claim 13, wherein the storage assembly further comprises a first case configured to encase a second drum of the musical drum set, the first case comprises:
a first round flexible base;
a first skirt that extends from a periphery of the first round flexible base, a diameter of the first round flexible base is proportional to an outer diameter of the second drum, a width of the first skirt is proportional to a height of the second drum, and
a plurality of first drawstrings extends from a periphery of the first skirt,
wherein the method further comprises the steps of:
placing the second drum over the first round flexible base;
lifting the first skirt, such that the first skirt is around the second drum;
fastening the plurality of first drawstrings together to secure the first case around the second drum; and
upon fastening the plurality of first drawstrings, placing the second drum over the first drum encased in the dolly.

15. The method according to claim 14, wherein the second drum is smaller in size than the first drum.
